(19) United States
(12) Patent Application Publication
(10) Pub. No.: US 2025/0382005 A1
(43) Pub. Date: Dec. 18, 2025

(54) SYSTEMS AND METHODS FOR MINIMALLY REALIZABLE DRIVER TORQUE ESTIMATION FOR STEERING APPLICATIONS

(71) Applicant: STEERING SOLUTIONS IP HOLDING CORPORATION, Saginaw, MI (US)

(72) Inventors: Vidit V. PANDYA; Prerit PRAMOD, Saginaw, MI (US)

(21) Appl. No.: 19/230,267

(22) Filed: Jun. 6, 2025

Related U.S. Application Data
(60) Provisional application No. 63/659,310, filed on Jun. 12, 2024.

(51) Int. Cl. B62D 6/10

(52) U.S. Cl. CPC B62D 6/10

(57) ABSTRACT

A system for estimating driver torque in a steering system is configured to receive at least one handwheel position value; estimate a handwheel velocity value based on the at least one handwheel position value; receive at least one residual torque value; and estimate a driver torque based on the estimated handwheel velocity and the at least one residual torque value.

### CROSS REFERENCE TO RELATED APPLICATIONS

This U.S. Non-Provisional Patent Application claims the benefit of and priority to U.S. Provisional Patent Application Ser. No. 63/659,310 filed Jun. 12, 2024, the contents of which are incorporated herein by reference in its entirety.

### TECHNICAL FIELD

This disclosure relates to steering systems, and in particular, to systems and methods for minimally realizable driver torque estimation for steering applications.

### BACKGROUND

A vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an electronic power steering (EPS) system, a steer-by-wire (SbW) steering system, a hydraulic steering system, or other suitable steering system and/or other suitable systems (e.g., such as a braking system, propulsion system, and the like). Such systems of the vehicle typically control various aspects of vehicle steering (e.g., including providing steering assist to an operator of the vehicle, controlling steerable wheels of the vehicle, and the like), vehicle propulsion, vehicle braking, and the like.

### SUMMARY

This disclosure relates generally to steering systems.

An aspect of the disclosed embodiments includes a system for estimating driver torque in a steering system. The system includes a processor, and a memory. The memory includes instructions that, when executed by the processor, cause the processor to: estimate a driver torque; and selectively control at least one aspect of a steering system based on the estimated driver torque.

Another aspect of the disclosed embodiments includes a method for estimating driver torque in a steering system. The method includes estimating a driver torque, and selectively controlling at least one aspect of a steering system based on the estimated driver torque.

Another aspect of the disclosed embodiments includes a system for estimating driver torque in a steering system. The system includes a processor, and a memory. The memory includes instructions that, when executed by the processor, cause the processor to: receive at least one handwheel position value; estimate a handwheel velocity value based on the at least one handwheel position value; receive at least one residual torque value; and estimate a driver torque based on the estimated handwheel velocity and the at least one residual torque value.

Another aspect of the disclosed embodiments includes a method for estimating driver torque in a steering system. The method includes receiving at least one handwheel position value, estimating a handwheel velocity value based on the at least one handwheel position value, receiving at least one residual torque value, and estimating a driver torque based on the estimated handwheel velocity and the at least one residual torque value.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIGS. 3-9 generally illustrate block diagrams of a driver torque estimation system according to the principles of the present disclosure.

FIG. 10 is a flow diagram generally illustrating driver torque estimation method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes various systems, such as a steering system, which may include an EPS system, an SbW steering system, a hydraulic steering system, or other suitable steering system and/or other suitable systems (e.g., such as a braking system, propulsion system, and the like). Such systems of the vehicle typically controls various aspects of vehicle steering (e.g., including providing steering assist to an operator of the vehicle, controlling steerable wheels of the vehicle, and the like), vehicle propulsion, vehicle braking, and the like.

Steering applications such as traditional EPS have a core focus of assisting a driver by reducing the effort to make steering maneuvers. Alternatively, (SbW) applications synthesize an optimal level of effort against the driver actions to emulate steering feel. For all steering applications, the torque applied by the driver cannot directly be sensed and hence is estimated using various estimation strategies. The estimated driver torque (e.g., a force applied by the driver or vehicle operator on a steering input, such as a handwheel) may then be used for advanced algorithms, such as hands-on-wheel detection, driver intent detection during certain maneuvers, etc.

Driver torque is typically estimated via complex observer architectures for accurate and reliable estimation. However, this embeds complexity in the overall system and is susceptible to failure as multiple sensor inputs are involved. The currently used approach requires extensive tuning and is applicable only for torque sensor-based columns, thus cannot be applied to other systems.

Accordingly, systems and methods, such as those described herein, configured to provided improved driver torque estimation, may be desirable. In some embodiments the systems and methods described herein may be configured to provide a minimally realizable design for driver torque estimation for SbW applications. The systems and methods described herein may be configured to provide simpler observer architecture, having higher robustness, and a gain setting technique that provides easier tunability, thus reducing the time and effort required for implementation. Furthermore, this approach may be utilized for multiple design variants for EPS or SbW applications such as handwheel torque sensor based or sensorless designs.

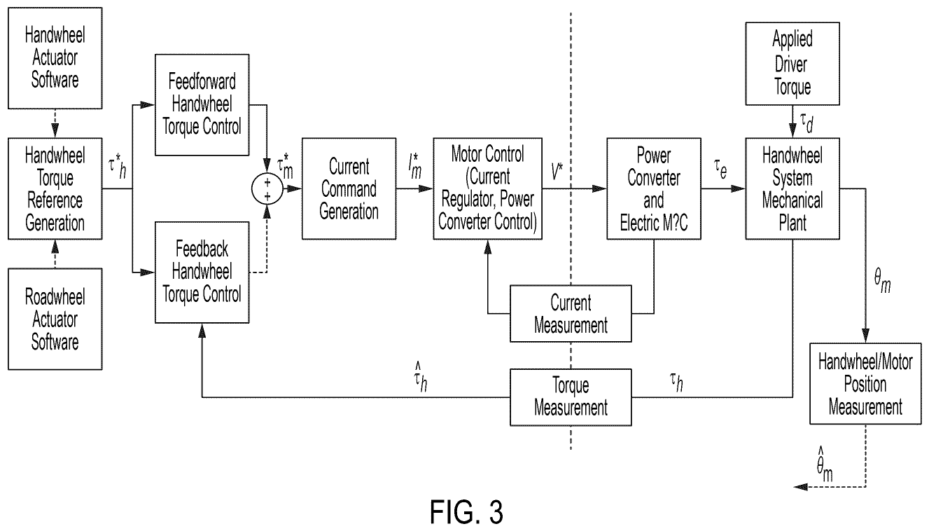

The general higher level functional architecture for a SbW handwheel system is shown in FIG. 3. The two primary modes of control within such a handwheel actuator are the current control loop and the torque control loop. Torque control is performed by utilizing feedback from torque sensor, or by implementing feedforward control in absence of torque sensing or as a redundant mode during torque sensor failure. The torque regulator acts on the reference torque command requested by the SbW system to generate a motor torque command. The motor torque command is then converted to an equivalent current command which is further regulated based on the measured current to generate a voltage command.

The torsion bar torque (colloquially, handwheel torque) signal is sensed via a torque sensor present on the lower end of the torsion bar, however, it does not provide information solely on the torque applied by the driver. This makes it challenging to estimate the driver torque precisely. Similarly for steering configurations that do not employ a torsion bar and hence a torque sensor, driver torque estimation is equally (if not more) challenging due to absence of any sensing mechanism. Accurately estimating driver torque is crucial for modern steering applications as multiple ADAS functions rely on the driver torque signal as a primary input.

In some embodiments, the systems and methods described herein may be configured to provide a generalized minimally realizable linear state observer for driver torque applicable to different steering configurations. Further, two specific observer gain tuning strategies that allow easier and intuitive tunability may be used.

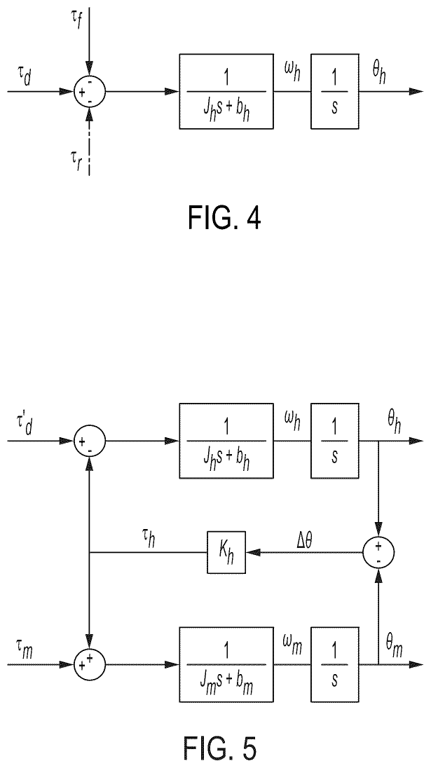

The general model for the handwheel actuator mechanical system may be given as:

$${τ}_{d} - {τ}_{f} = {J}_{h} {\ddot{θ}}_{h} + {b}_{h} {\dot{θ}}_{h} + {τ}_{r} \qquad ( 1 )$$

where τd, τr, are the driver and residual torque respectively. Residual torque may refer to a torque value associated with a torque remaining in steering components after an input force (e.g., handwheel torque) has been removed. For example, the residual torque may be associated with internal resistance or friction within a steering rack, various gears, brushings, and/or the like (e.g., for EPS or the like steering systems). Additionally, or alternatively, with respect to SbW steering systems, the residual torque may be associated with remaining torque or resistance in a steering actuator or feedback motor, after the driver input is removed. The residual torque may be determined based on a sensor measurement and/or estimated, as described herein. Jh and bh are the mechanical constants (inertia and damping) for the handwheel and θh is the handwheel angle. τf is the lumped friction term as a function of Coulomb friction, aerodynamical drag, and other friction components that may act on the handwheel based on the design. The block diagram for such a system may be given as shown in FIG. 4.

For simplicity in modeling the driver torque and friction component have been lumped together as τd′, hence:

$${τ}_{d}^{′} = {τ}_{d} - {τ}_{f} \qquad ( 2 )$$

Equivalently, it may be assumed that analytically modeled τf may be lumped within τl for simplicity in modeling. Hence the transfer function may be written as:

$${θ}_{h} = \frac{1}{{J}_{h} {s}^{2} + {b}_{h} s} ( {τ}_{d}^{′} - {τ}_{r} ) \qquad ( 3 )$$

Based on the general model, different cases may be modeled based on application. In some embodiments, the systems and methods described herein may be configured to provide 2 cases, as examples, based on availability of torque sensing, which have been modeled and described herein.

Case 1—Sensor based SbW or EPS application. Case 2—Sensorless SbW or EPS application. Sensor based SbW or EPS application. The handwheel actuator mechanical system for a T-bar based system can be represent as a 2-mass model as shown in FIG. 4. The governing equations for the 2-mass model are as follows:

$${τ}_{d}^{′} - {τ}_{h} = {J}_{h} {\ddot{θ}}_{h} + {b}_{h} {\dot{θ}}_{h} \qquad ( 4 )$$

$${τ}_{h} = {K}_{h} ( {θ}_{h} - {θ}_{m} )$$

$${τ}_{m} + {τ}_{h} = {J}_{m} {\ddot{θ}}_{m} + {b}_{m} {\dot{θ}}_{m}$$

where τh, τm are the handwheel and motor torque respectively. θm is the motor angle in the handwheel frame of reference. Jm and bm are the mechanical constants (inertia and damping) for the motor, in the handwheel frame of reference. Kh is the T-bar compliance. Note that for this case τh is equivalent to τr (residual torque).

For this case the handwheel angle may be estimated from eq. 4, as

$${\hat{θ}}_{h} = \frac{{\hat{τ}}_{h}}{{\overline{K}}_{h}} + {\hat{θ}}_{m} \qquad ( 5 )$$

Sensorless SbW or EPS application. The handwheel actuator mechanical system for a T-barless system may be presented as a 1-mass model and may be written as follows—

$${τ}_{d}^{′} - {τ}_{m} = {J}_{h}^{′} {\ddot{θ}}_{h} + {b}_{h}^{′} {\dot{θ}}_{h} \qquad ( 6 )$$

Note that for a sensorless system, due to high column stiffness the handwheel angle and motor angle in handwheel frame of reference are the same. Furthermore, Jh′ and bh′ represent the lumped inertia and damping terms to account for both handwheel and motor parameters. Here τm is equivalent to the residual torque.

In some embodiments, the systems and methods described herein may be configured to provide a minimally realizable state observer. The generalized handwheel actuator system can be represented as a combination of three states, the handwheel angle, handwheel velocity and driver torque. However, it can also be represented as a minimal realization with just two states by eliminating handwheel angle. A minimal realization is a representation of a system with the least number of state variables without losing information on the system behavior. Such a representation ensures that the observer can estimate the state with precision with the minimum amount of system information. Hence an observer design based on such a system representation can be generalized to many applications as it can be implemented with the lowest number of measurements possible.

Converting the general model to a minimal state system, θh may be replaced by ωh and represented as follows:

$${τ}_{d}^{′} - {τ}_{r} = {J}_{h} {\dot{ω}}_{h} + {b}_{h} {ω}_{h} \qquad ( 7 )$$

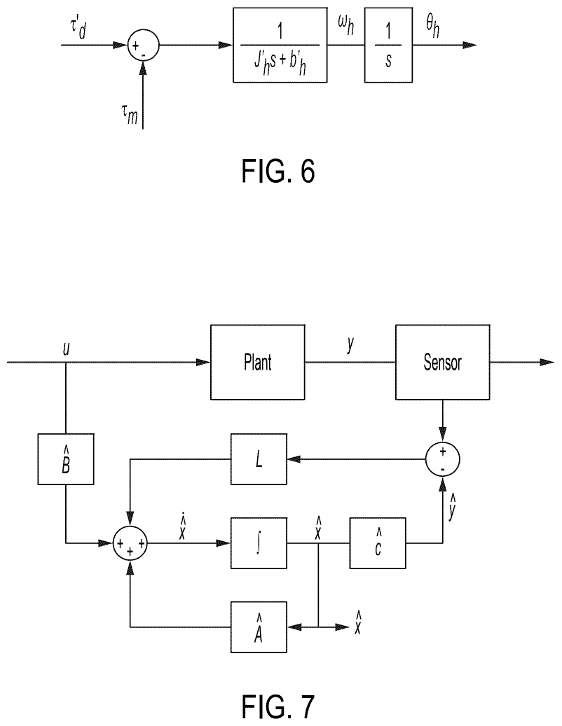

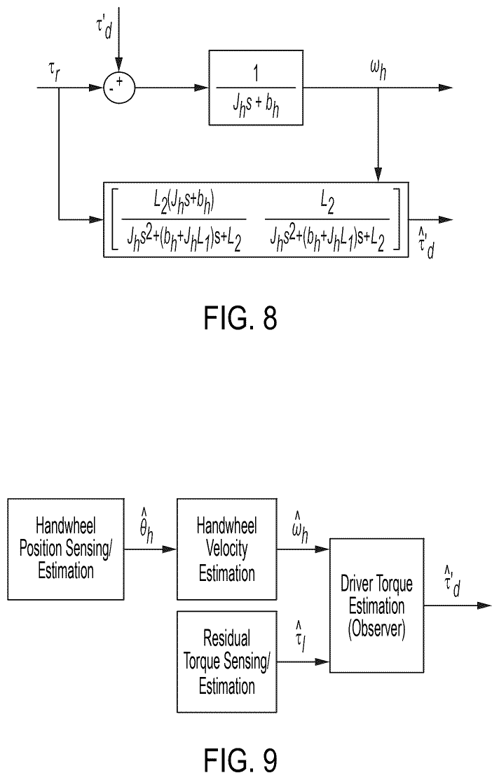

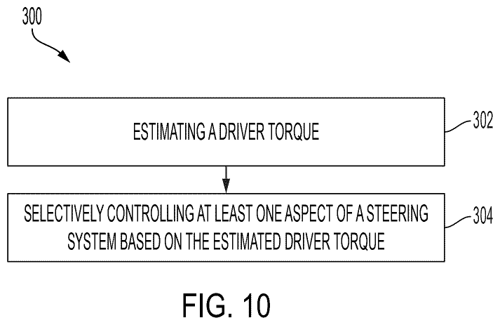

As is generally illustrated in FIGS. 4-9 a minimal state system is show, with a Luenberger state estimator is shown in FIG. 7. Luenberger estimators are analytical linear state estimators that enable estimation of one or more state variables \hat{x} of the plant. Matrices Â, \hat{B} and Ĉ are derived from the state space representation of the plant and estimated parameters. Matrix L is the observer gain matrix that drives the characteristics of the observer.

In some embodiments, the residual torque is modeled as an input to the system and the driver torque is modeled as a state of the system with the assumption of an unknown initial condition. As the derivative of an unknown step function is zero, the minimal state system may be represented as a state space model as follows:

$$[ \begin{matrix}{{ω}^{\dot{\hat{}}}}_{h} \\ {{τ}^{\dot{\hat{}}}}_{d}^{′}\end{matrix} ] = [ \begin{matrix}- \frac{{\hat{b}}_{h}}{{\hat{J}}_{h}} & \frac{1}{{\hat{J}}_{h}} \\ 0 & 0\end{matrix} ] [ \begin{matrix}{\hat{ω}}_{h} \\ {\hat{τ}}_{d}^{′}\end{matrix} ] + [ \begin{matrix}- \frac{1}{{\hat{J}}_{h}} \\ 0\end{matrix} ] {\hat{τ}}_{r} \qquad ( 8 )$$

$$\hat{y} = [ \begin{matrix}1 & 0\end{matrix} ] [ \begin{matrix}{\hat{ω}}_{h} \\ {\hat{τ}}_{d}^{′}\end{matrix} ]$$

After examining the observability criteria for the systems and methods described herein, a linear observer may be designed as follows—

$$[ \begin{matrix}{{ω}^{\dot{\hat{}}}}_{h} \\ {{τ}^{\dot{\hat{}}}}_{d}^{′}\end{matrix} ] = [ \begin{matrix}- \frac{{\hat{b}}_{h}}{{\hat{J}}_{h}} & \frac{1}{{\hat{J}}_{h}} \\ 0 & 0\end{matrix} ] [ \begin{matrix}{\hat{ω}}_{h} \\ {\hat{τ}}_{d}^{′}\end{matrix} ] + [ \begin{matrix}- \frac{1}{{\hat{J}}_{h}} \\ 0\end{matrix} ] {\hat{τ}}_{r} + [ \begin{matrix}{L}_{1} \\ {L}_{2}\end{matrix} ] ( y - \hat{y} ) \qquad ( 9 )$$

where L1 and L2 are the observer gains. This may be simplified and written in the following form—

$$[ \begin{matrix}{{ω}^{\dot{\hat{}}}}_{h} \\ {{τ}^{\dot{\hat{}}}}_{d}\end{matrix} ] = [ \begin{matrix}- \frac{{\hat{b}}_{h}}{{\hat{J}}_{h}} - {L}_{1} & \frac{1}{{\hat{J}}_{h}} \\ - {L}_{2} & 0\end{matrix} ] [ \begin{matrix}{\hat{ω}}_{h} \\ {\hat{τ}}_{d}\end{matrix} ] + [ \begin{matrix}- \frac{1}{{\hat{J}}_{h}} \\ 0\end{matrix} ] {\hat{τ}}_{r} + [ \begin{matrix}{L}_{1} \\ {L}_{2}\end{matrix} ] y \qquad ( 10 )$$

The error dynamics between the plant the model may be modeled as follows. Note that the estimated parameters are assumed to be the same as the actual parameters.

$$\dot{ϵ} = [ \begin{matrix}{\dot{ω}}_{h} \\ {τ}_{d}^{\dot{′}}\end{matrix} ] - [ \begin{matrix}{{ω}^{\dot{\hat{}}}}_{h} \\ {\hat{τ}}_{d}^{\dot{′}}\end{matrix} ] \qquad ( 11 )$$

$$\dot{ϵ} = [ \begin{matrix}- \frac{{\hat{b}}_{h}}{{\hat{J}}_{h}} - {L}_{1} & \frac{1}{{\hat{J}}_{h}} \\ - {L}_{2} & 0\end{matrix} ] [ \begin{matrix}{\tilde{ω}}_{h} \\ {\tilde{τ}}_{d}^{′}\end{matrix} ]$$

where \tilde{ω}h and \tilde{ω}d are the error terms and can be written as follows—

$${\tilde{ω}}_{h} = {ω}_{h} - {\hat{ω}}_{h} \qquad ( 12 )$$

$${\tilde{τ}}_{d}^{′} = {τ}_{d}^{′} - {\hat{τ}}_{d}^{′}$$

Furthermore, an expression may be derived for the estimated driver torque based on the (eq. 10) as a function of the residual torque and the handwheel velocity to clearly state the relationship between the available measured/estimated signals and the observed state. Note that here also, it is assumed that the estimated and actual parameters are the same.

$${\hat{τ}}_{d}^{′} = \frac{{L}_{2} ( {\hat{J}}_{h} s + {\hat{b}}_{h} )}{{\hat{J}}_{h} {s}^{2} + ( {\hat{b}}_{h} + {\hat{J}}_{h} {L}_{1} ) s + {L}_{2}} {ω}_{h} + \frac{{L}_{2}}{{\hat{J}}_{h} {s}^{2} + ( {\hat{b}}_{h} + {\hat{J}}_{h} {L}_{1} ) s + {L}_{2}} {τ}_{r} \qquad ( 13 )$$

An alternative representation of the block diagram with the plant and the minimally realizable observer is shown below. For deriving the observer transfer function, substituting ωh from the plant transfer function in eq. 13, giving the following expression:

$${\hat{τ}}_{d}^{′} = \frac{{L}_{2}}{{\hat{J}}_{h} {s}^{2} + ( {\hat{b}}_{h} + {\hat{J}}_{h} {L}_{1} ) s + {L}_{2}} {τ}_{d}^{′} \qquad ( 14 )$$

Based on eq. 14, the observer can be tuned via different techniques to achieve desired frequency response.

While various model-based or theoretical techniques may be used for tuning the observer gains, two analytical approaches based on the dynamics of the given observer system have been detailed here for intuitive and easy observer gain tuning.

In some embodiments, the poles of the observer are selected such that they are x times faster than the plant poles. It is important to note that to maximize the bandwidth of the observer the scalar x may be scheduled as a function of one or more signals.

From the characteristic equation of the error dynamics matrix, using the above strategy the following observer gains are selected such that the poles are x times faster than the plant pole −bh/Jh:

$${L}_{1} = \frac{{\hat{b}}_{h}}{{\hat{J}}_{h}} ( 2 x - 1 ) \qquad ( 13 )$$

$${L}_{2} = \frac{{\hat{b}}_{h}^{2} {x}^{2}}{{\hat{J}}_{h}}$$

Additional, or alternative embodiments are based on achieving second order observer transfer function response. The gains are selected such that the bandwidth and damping characteristics of the observer may be governed to produce desired observer response, shown as:

$${L}_{1} = 2 ζ {ω}_{n} - \frac{{\hat{b}}_{h}}{{\hat{J}}_{h}} \qquad ( 13 )$$

$${L}_{2} = {ω}_{n}^{2} {\hat{J}}_{h}$$

Here ζ and ωn represent the desired natural frequency and damping ratio of the second order transfer function. Thus, approach 2 gives superior tuning flexibility as the observer bandwidth may be precisely controlled to avoid instabilities due to delays in the actual system based on application.

The frequency response of the observer may be based on different values of ζ and ωn. For the implementation of the aforementioned observer design for driver torque estimation, the following architecture may be implemented, where the driver torque estimation block consists of a discrete implementation of eq. 14. Note that based on the system friction, an analytical friction component may be subtracted from the observed state for precise results.

As described herein, based on the steering configuration, the definition of the residual torque may change and the source for the handwheel angle may be different. However, for any EPS or SbW system the residual torque and handwheel angle are the signals which would always be available as measured or estimated quantities. For any steering architecture, the systems and methods described herein may be configured to provide the (e.g., relatively) simplest driver torque observer design requiring the least number of inputs.

Simulation results indicate that the observer is robust towards small parameter estimation errors, however it may be noted that gain tuning approach two is the superior approach. In some embodiments, the systems and methods described herein may be configured to provide a generalized architecture for minimally realizable observer for reliable, robust, and easily tunable driver torque estimation. The systems and methods described herein may be configured to utilize a minimum number of steering signals enabling the broadest, most generalized application of the systems and methods described herein. The systems and methods described herein may be configured to provide an analytical gain tuning approach for stable, robust, and simply tunable observer implementation for different steering configurations.

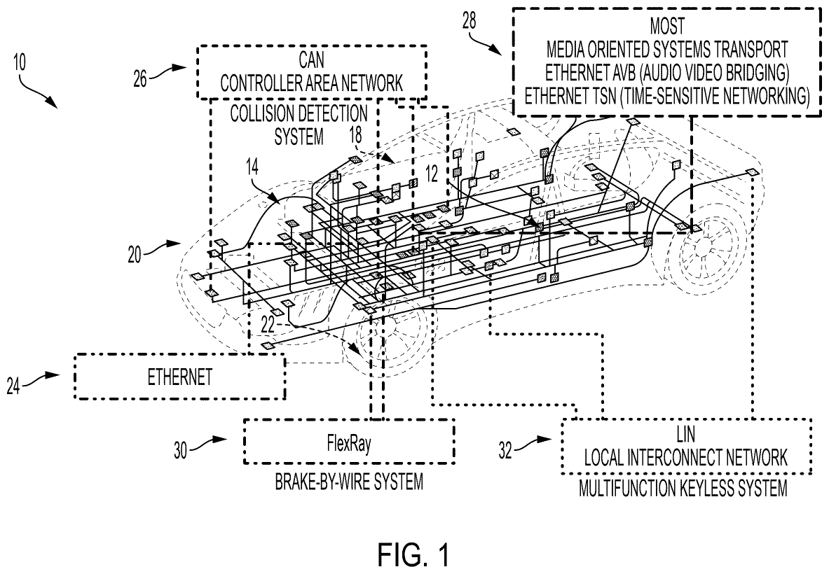

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

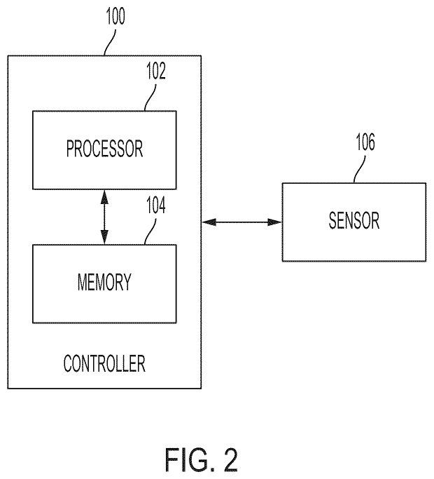

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more radar sensors or devices, one or more lidar sensors or devices, one or more sonar sensors or devices, one or more image capturing sensors or devices, other suitable sensors or devices, or a combination thereof. The one or more signals may indicate a handwheel torque, a handwheel angle, a motor velocity, a vehicle speed, other suitable information, or a combination thereof.

In some embodiments, the controller 100 may be configured to estimate driver torque in a steering system. For example, the controller 100 may estimate a driver torque. The controller 100 may selectively control at least one aspect of the steering system of the vehicle 10 based on the estimated driver torque.

In some embodiments, the controller 100 may estimate driver torque in a steering system. For example, the controller 100 may receive at least one handwheel position value. The controller 100 may estimate a handwheel velocity value based on the at least one handwheel position value. The controller 100 may receive at least one residual torque value. The controller 100 may estimate a driver torque based on the estimated handwheel velocity and the at least one residual torque value.

In some embodiments, the controller 100 may perform the methods described herein. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

FIG. 4 is a flow diagram generally illustrated a driver torque estimation method 300 according to the principles of the present disclosure. At 302, the method 300 estimates a driver torque.

At 304, the method 300 selectively controls at least one aspect of a steering system based on the estimated driver torque.

In some embodiments, the method 300 may further include estimating driver torque in a steering system by receiving at least one handwheel position value, estimating a handwheel velocity value based on the at least one handwheel position value, receiving at least one residual torque value, and estimating a driver torque based on the estimated handwheel velocity and the at least one residual torque value.

In some embodiments, a system for estimating driver torque in a steering system includes a processor, and a memory. The memory includes instructions that, when executed by the processor, cause the processor to: estimate a driver torque; and selectively control at least one aspect of a steering system based on the estimated driver torque.

In some embodiments, a method for estimating driver torque in a steering system includes estimating a driver torque, and selectively controlling at least one aspect of a steering system based on the estimated driver torque.

In some embodiments, a system for estimating driver torque in a steering system includes a processor, and a memory. The memory includes instructions that, when executed by the processor, cause the processor to: receive at least one handwheel position value; estimate a handwheel velocity value based on the at least one handwheel position value; receive at least one residual torque value; and estimate a driver torque based on the estimated handwheel velocity and the at least one residual torque value.

In some embodiments, the at least one handwheel position value corresponds to a measured position of a handwheel. In some embodiments, the measured position of the handwheel corresponds to one or more measurements received from one or more sensors. In some embodiments, the at least one handwheel position value corresponds to an estimated handwheel position of a handwheel. In some embodiments, the at least one residual torque value corresponds to a measured residual torque of one or more components of the steering system. In some embodiments, the measured residual torque corresponds to one or more measurements received from one or more sensors. In some embodiments, the at least one residual torque value corresponds to an estimated residual torque of one or more components of the steering system. In some embodiments, estimating a driver torque includes modeling the driver torque as a state of the steering system. In some embodiments, estimating a driver torque includes using at least one Luenberger estimator. In some embodiments, the steering system includes a steer-by-wire steering system.

In some embodiments, a method for estimating driver torque in a steering system includes receiving at least one handwheel position value, estimating a handwheel velocity value based on the at least one handwheel position value, receiving at least one residual torque value, and estimating a driver torque based on the estimated handwheel velocity and the at least one residual torque value.

In some embodiments, the at least one handwheel position value corresponds to a measured position of a handwheel. In some embodiments, the measured position of the handwheel corresponds to one or more measurements received from one or more sensors. In some embodiments, the at least one handwheel position value corresponds to an estimated handwheel position of a handwheel. In some embodiments, the at least one residual torque value corresponds to a measured residual torque of one or more components of the steering system. In some embodiments, the measured residual torque corresponds to one or more measurements received from one or more sensors. In some embodiments, the at least one residual torque value corresponds to an estimated residual torque of one or more components of the steering system. In some embodiments, estimating a driver torque includes modeling the driver torque as a state of the steering system. In some embodiments, estimating a driver torque includes using at least one Luenberger estimator. In some embodiments, the steering system includes a steer-by-wire steering system.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A system for estimating driver torque in a steering system, the system comprising:
a processor; and
a memory including instructions that, when executed by the processor, cause the processor to:
receive at least one handwheel position value;
estimate a handwheel velocity value based on the at least one handwheel position value;
receive at least one residual torque value; and
estimate a driver torque based on the estimated handwheel velocity and the at least one residual torque value.

2. The system of claim 1, wherein the at least one handwheel position value corresponds to a measured position of a handwheel.

3. The system of claim 2, wherein the measured position of the handwheel corresponds to one or more measurements received from one or more sensors.

4. The system of claim 1, wherein the at least one handwheel position value corresponds to an estimated handwheel position of a handwheel.

5. The system of claim 1, wherein the at least one residual torque value corresponds to a measured residual torque of one or more components of the steering system.

6. The system of claim 5, wherein the measured residual torque corresponds to one or more measurements received from one or more sensors.

7. The system of claim 1, wherein the at least one residual torque value corresponds to an estimated residual torque of one or more components of the steering system.

8. The system of claim 1, wherein estimating a driver torque includes modeling the driver torque as a state of the steering system.

9. The system of claim 1, wherein estimating a driver torque includes using at least one Luenberger estimator.

10. The system of claim 1, wherein the steering system includes a steer-by-wire steering system.

11. A method for estimating driver torque in a steering system, the method comprising:
receiving at least one handwheel position value;
estimating a handwheel velocity value based on the at least one handwheel position value;
receiving at least one residual torque value; and
estimating a driver torque based on the estimated handwheel velocity and the at least one residual torque value.

12. The method of claim 11, wherein the at least one handwheel position value corresponds to a measured position of a handwheel.

13. The method of claim 12, wherein the measured position of the handwheel corresponds to one or more measurements received from one or more sensors.

14. The method of claim 11, wherein the at least one handwheel position value corresponds to an estimated handwheel position of a handwheel.

15. The method of claim 11, wherein the at least one residual torque value corresponds to a measured residual torque of one or more components of the steering system.

16. The method of claim 15, wherein the measured residual torque corresponds to one or more measurements received from one or more sensors.

17. The method of claim 11, wherein the at least one residual torque value corresponds to an estimated residual torque of one or more components of the steering system.

18. The method of claim 11, wherein estimating a driver torque includes modeling the driver torque as a state of the steering system.

19. The method of claim 11, wherein estimating a driver torque includes using at least one Luenberger estimator.

20. The method of claim 11, wherein the steering system includes a steer-by-wire steering system.
